(19) United States
(12) Patent Application Publication
(10) Pub. No.: US 2019/0083335 A1
(43) Pub. Date: Mar. 21, 2019

(54) TRAVEL TOOL CONTROL METHOD, DEVICE AND SYSTEM

(71) Applicant: BOE TECHNOLOGY GROUP CO., LTD., Beijing (CN)

(72) Inventors: Yifei ZHANG, Beijing (CN); Zuo YUAN, Beijing (CN)

(73) Assignee: BOE TECHNOLOGY GROUP CO., LTD., Beijing (CN)

(21) Appl. No.: 15/563,081

(22) PCT Filed: Apr. 5, 2017
(86) PCT No.: PCT/CN2017/079448

§ 371 Date: Sep. 29, 2017

(30) Foreign Application Priority Data
Jun. 7, 2016 (CN) 201610398690.X

(51) Int. Cl. A61G 5/04; G06F 3/01; G06K 9/00; A61G 5/10

(52) U.S. Cl. CPC A61G 5/04; G06F 3/013; G06K 9/0061; A61G 2203/30; A61G 2203/18; G06F 2203/011; A61G 2203/20; A61G 5/1051

(57) ABSTRACT

A travel tool control method includes: capturing an eyeball image of a user; recognizing an eyeball action of the user based on the eyeball image of the user; and generating a travel tool operation instruction to instruct the travel tool to perform an operation corresponding to the eyeball action of the user. A travel tool control device includes a camera, configured to capture an eyeball image of a user; an image processing circuit, coupled with the camera and configured to recognize an eyeball action of the user based on the eyeball image of the user; and a control circuit, coupled with the image processing circuit and configured to generate a travel tool operation instruction to instruct the travel tool to perform an operation corresponding to the eyeball action of the user.

### CROSS-REFERENCE TO RELATED APPLICATION

The present application claims priority to Chinese Patent Application No. 201610398690.X filed on Jun. 7, 2016, the disclosure of which is hereby incorporated by reference in its entirety.

### TECHNICAL FIELD

The present disclosure is related generally to control technologies, and more specifically to a travel tool control method, a travel tool control device, and a travel tool control system.

### BACKGROUND

In current travel tool technologies, a conventional wheelchair needs to be operated by hand or foot of a user, or can be driven by electric power and maneuvered by pressing buttons. It is, however, difficult for people with limb disabilities, such as patients with amyotrophic lateral sclerosis, who typically cannot use hands or sound, and are thus excluded from using these conventional wheelchairs. As such, a wheelchair that can be operated without moving any body parts such as legs, arms or hands, is needed.

### SUMMARY

In order to address the issues associated with current travel tool technologies, the present disclosure provides a travel tool control method, a travel tool control device, and a travel tool control system.

In a first aspect, a travel tool control method for controlling a travel tool by a user is disclosed.

The method comprises the following three steps:

capturing an eyeball image of the user;

recognizing an eyeball action of the user based on the eyeball image of the user; and

generating a travel tool operation instruction to instruct the travel tool to perform an operation corresponding to the eyeball action of the user.

According to some embodiments of the present disclosure, the step of recognizing an eyeball action of the user based on the eyeball image of the user includes the following two sub-steps:

determining coordinates of at least one pupil from the eyeball image of the user; and

determining an eyeball action of the user by comparing the coordinates of the at least one pupil with coordinates of the at least one pupil in at least one pre-stored eyeball images of the user, wherein each pre-stored eyeball image of the user corresponds to one eyeball action of the user.

Herein the sub-step of determining coordinates of at least one pupil from the eyeball image of the user can be based on differences in gray values among whites, iris, and pupil in the eyeball image of the user.

Herein the sub-step of determining an eyeball action of the user by comparing the coordinates of the at least one pupil with coordinates of the at least one pupil in at least one pre-stored eyeball images can further include:

determining whether a difference between the coordinates of the at least one pupil and the coordinates of the at least one pupil of any pre-stored eyeball image is within a preset range; and

if so, determining that the eyeball action of the user is an eyeball action corresponding to the any pre-stored eyeball image.

Between the step of recognizing an eyeball action of the user based on the eyeball image of the user and the step of generating a travel tool operation instruction to instruct the travel tool to perform an operation corresponding to the eyeball action of the user, the method can further include the following steps:

starting an eyeball control upon receiving a starting-eyeball-control instruction from the user; and

determining whether the travel tool is in an operation ready state, and if no, generating a preparing-for-operation instruction to instruct the travel tool to adjust to the operation ready state to thereby allow the travel tool to perform an operation corresponding to the eyeball action of the user.

After the step of generating a travel tool operation instruction to instruct the travel tool to perform an operation corresponding to the eyeball action of the user, the method can further comprise the following steps:

prompting the user whether to perform the operation corresponding to the eyeball action of the user; and

transmitting the travel tool operation instruction to the travel tool upon receiving a confirming instruction from the user.

After the step of transmitting the travel tool operation instruction to the travel tool upon receiving a confirming instruction from the user, the method can further include the following step:

terminating the eyeball control upon receiving a terminating-eyeball-control instruction from the user.

In any of the embodiments as mentioned above, the eyeball action can include LOOK LEFT, LOOK RIGHT, LOOK UP, and LOOK DOWN, which correspond to the travel tool moving left, right, forward, and backward, respectively.

In a second aspect, the present disclosure further provides a travel tool control device.

The travel tool control device comprises a camera, an image processing circuit, and a control circuit. The camera is configured to capture an eyeball image of a user. The image processing circuit is coupled with the camera, and is configured to recognize an eyeball action of the user based on the eyeball image of the user. The control circuit is coupled with the image processing circuit, and is configured to generate a travel tool operation instruction to instruct the travel tool to perform an operation corresponding to the eyeball action of the user.

In some embodiments of the travel tool control device, the image processing circuit comprises a coordinates determining subcircuit and an action determining subcircuit. The coordinates determining subcircuit is configured to determine coordinates of at least one pupil from the eyeball image of the user; and the action determining subcircuit is configured to determine the eyeball action of the user by comparing the coordinates of the at least one pupil with coordinates of the at least one pupil in at least one pre-stored eyeball images of the user, wherein each pre-stored eyeball image of the user corresponds to one eyeball action of the user.

According to some embodiments of present disclosure, the travel tool control device further includes an operation preparing circuit. The operation preparing circuit is coupled with the image processing circuit, and is configured to determine whether the travel tool is in an operation ready state after the image processing circuit recognizes the eyeball action of the user and receives a starting-eyeball-control instruction from the user; and if no, the operation preparing circuit is configured to generate a preparing-for-operation instruction to instruct the travel tool to adjust to the operation ready state to thereby allow the travel tool to perform an operation corresponding to the eyeball action of the user.

According to some embodiments of present disclosure, the travel tool control device further includes a prompting circuit and a transmitting circuit. The prompting circuit is configured to prompt the user whether to perform the operation corresponding to the eyeball action of the user after the image processing circuit recognizes the eyeball action of the user. The transmitting circuit is configured to transmit the travel tool operation instruction to the travel tool upon receiving a confirming instruction from the user.

The travel tool control device can further include an operation termination circuit, which is configured to receive a terminating-eyeball-control instruction from the user; and is also configured to generate a terminating-operation instruction based on the terminating-eyeball-control instruction from the user so as to stop the travel tool and to shut down the transmitting circuit.

According to some embodiments of present disclosure, the travel tool control device further comprises a communication circuit. The communication circuit is coupled with the camera and the image processing circuit, and is configured to transmit the eyeball image of the user to the image processing circuit.

In any of the embodiments of the travel tool control device, the camera can be on a goggle which is worn by the user.

In a third aspect, the present disclosure further provides a travel tool system.

The travel tool system includes a travel tool and a travel tool control device. The travel tool control device can be based on any of embodiments as mentioned above.

In the travel tool system, the travel tool can include at least one wheel, a motor, and a motor driver. The at least one wheel is configured to provide a moving means for the travel tool. The motor is configured to drive the at least one wheel. The motor driver is coupled with an instruction outputting end of the travel tool control device and is configured to control the motor.

According to some embodiments of the travel tool system, the at least one wheel can include at least one omnidirectional wheel. Herein the at least one omnidirectional wheel can comprise at least one Mecanum wheel.

According to some embodiments of present disclosure, the travel tool system can further comprise a stop button and a safety control panel. The stop button is configured to receive a forced stop instruction. The safety control panel is coupled respectively to the stop button and the motor driver, and is configured to send a stopping-motor instruction to the motor driver upon receiving the forced stop instruction from the stop button.

Other embodiments may become apparent in view of the following descriptions and the attached drawings.

### BRIEF DESCRIPTION OF THE DRAWINGS

To more clearly illustrate some of the embodiments, the following is a brief description of the drawings. The drawings in the following descriptions are only illustrative of some embodiment. For those of ordinary skill in the art, other drawings of other embodiments can become apparent based on these drawings.

FIG. 1 is a schematic diagram of a travel tool control device according to some embodiments of the disclosure;

FIG. 2 illustrates a goggle in a travel tool control device according to some embodiments of the present disclosure;

FIG. 3 is a schematic diagram of a travel tool control device according to some embodiments of the disclosure;

FIG. 4 illustrates a pre-captured eyeball image of a user when the user is looking straight ahead;

FIG. 5 illustrates a pre-captured eyeball image of a user when the user is looking left;

FIG. 6 is a schematic diagram of a travel tool control device according to some embodiments of the disclosure;

FIG. 7 is a schematic diagram of a travel tool control device according to some embodiments of the disclosure;

FIG. 8 is a schematic diagram of a travel tool control device according to some embodiments of the disclosure;

FIG. 9 is a schematic diagram of a travel tool system according to some embodiments of the present disclosure;

FIG. 10 illustrates a travel tool system according to some embodiments of the present disclosure;

FIG. 11 is a schematic diagram of the travel tool system shown in FIG. 10;

FIG. 12 illustrates a working flowchart of a wheelchair system according to some embodiments of the present disclosure;

FIG. 13 illustrates the coordination of four Mecanum wheels in a wheelchair system realizing various movements of the wheelchair.

### DETAILED DESCRIPTION

In the following, with reference to the drawings of various embodiments disclosed herein, the technical solutions of the embodiments of the disclosure will be described in a clear and fully understandable way.

It is obvious that the described embodiments are merely a portion but not all of the embodiments of the disclosure. Based on the described embodiments of the disclosure, those ordinarily skilled in the art can obtain other embodiment(s), which come(s) within the scope sought for protection by the disclosure.

In order to solve the issue that it is typically inconvenient or impossible for people with limb disabilities or other disabilities to use a conventional travel tool, such as a wheelchair, the present disclosure provides a travel tool control method, a travel tool control device, and a travel tool system.

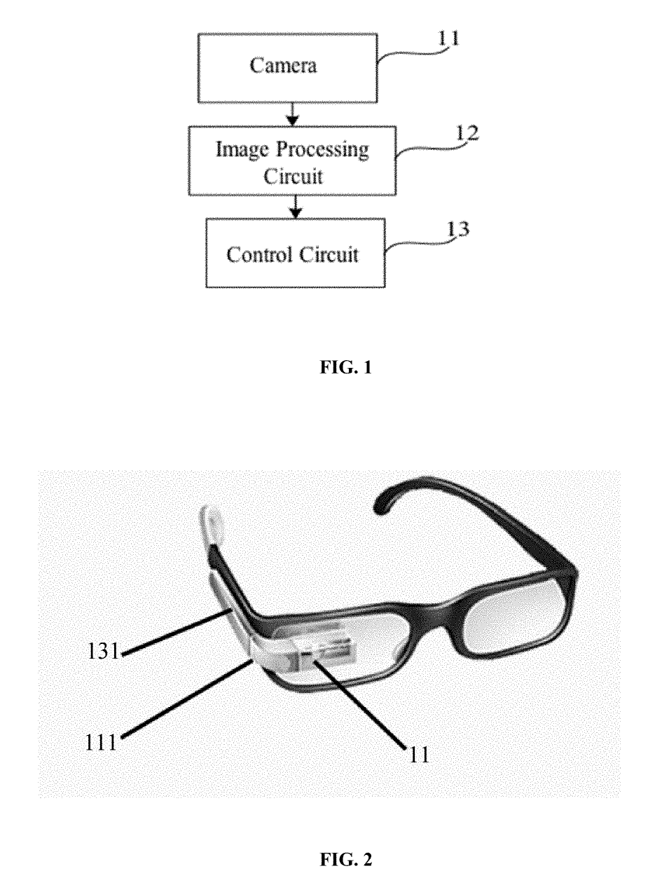

In one aspect, a travel tool control device is disclosed herein. FIG. 1 is a schematic diagram of a travel tool control device according to some embodiments of the disclosure. As shown in FIG. 1, the travel tool control device comprises a camera 11, an image processing circuit 12, and a control circuit 13.

The camera 11 is configured to capture an eyeball image of a user. The image processing circuit 12 is coupled with the camera 11 and is configured to recognize an eyeball action of the user upon receiving the eyeball image of the user. The control circuit 13, configured to generate a travel tool operation instruction (i.e. an instruction for controlling the travel tool to perform a certain operation) based on the eyeball action of the user.

In the travel tool control device as described above, a plurality of eyeball actions and a plurality of travel tool operation instructions can be preset and pre-stored, wherein each of the plurality of eyeball actions corresponds to each of the plurality of travel tool operation instructions respectively.

As one example, the travel tool can be a wheelchair, and the correspondence relationship between the plurality of eyeball actions and the plurality of wheelchair operation instructions can be illustrated in Table 1.

As shown in Table 1, the plurality of eyeball actions that have been preset and pre-stored include: “BLINK ONCE”, “BLINK TWICE”, “BLINK THREE TIMES”, “LOOK LEFT”, “LOOK RIGHT”, “LOOK UP” and “LOOK DOWN”. The action “LOOK LEFT” corresponds to an instruction to turn the wheelchair left; the action “LOOK RIGHT” corresponds to an instruction to turn the wheelchair right; the action “LOOK UP” corresponds to an instruction to move the wheelchair forward; the action “LOOK DOWN” corresponds to an instruction to move the wheelchair backward; the action “BLINK ONCE” corresponds to a confirming instruction (i.e. an instruction indicating confirmation); the action “BLINK TWICE” corresponds to an instruction to stop the wheelchair; and the action “BLINK THREE TIMES” corresponds to an instruction for starting eyeball control operation.

TABLE 1

| | WHEELCHAIR |
|---|---|
| EYEBALL ACTION | OPERATION |
| LOOK LEFT | TURN LEFT |
| LOOK RIGHT | TURN RIGHT |
| LOOK UP | MOVE FOWARD |
| LOOK DOWN | MOVE BACKWARD |
| BLINK ONCE | CONFIRM |
| BLINK TWICE | STOP |
| BLINK THREE TIMES | START |

It is noted that the eyeball actions and their respective correspondence relationship with the wheelchair operation instructions are arbitrary, and can be set based on practical conditions. Such a correspondence can be set before the wheelchair is put on the market, or can be customized by users. Additionally, the travel tool can be a balancing vehicle (such as a Segway) or an electric unicycle. There are no limitations herein.

The following is a detailed description of the travel tool control device using a wheelchair as an example. During operation, the camera 11 can be used to take an eyeball image of a user, and the eyeball image of the user can be further transmitted to the image processing circuit 12 via a wired or wireless communication, then by image recognition, the image processing circuit 12 can recognize an eyeball action of the user upon receiving the eyeball image of the user.

Then the control circuit 13 can query a correspondence table, which includes a preset and pre-stored correspondence relationship between eyeball actions and the wheelchair operation instructions, to thereby generate a corresponding wheelchair operation instruction based on the eyeball action of the user.

For example, if after image processing, the image processing circuit 12 recognizes an eyeball action is “LOOK LEFT”, the control circuit 13 generates an instruction to turn the wheelchair left, which is then transmitted to a power mechanism of the wheelchair to thereby realize a left-turn operation over the wheelchair.

By means of the travel tool control device as described above, an eyeball control can be realized to operate the travel tool, without the need to move legs, arms, hands, or other parts of the body. As such, the problem that conventional travel tools, such as wheelchairs, are difficult to operate for those with disabilities or handicaps, can be effectively solved.

As shown in FIG. 2, according to some embodiments of the present disclosure, the travel tool control device as described above can further comprise a goggle, wherein the camera 11 can be disposed on the goggle. The goggle can bring convenience for a user to wear, and can block the eyeball actions of the user during operation of the travel tool, so as to avoid drawing curiosity and attention from other people.

In a preferred embodiment as illustrated in FIG. 2, the camera 11 can be attached over one lens of the goggle. A communication circuit (such as a Bluetooth wireless communication circuit 111) and a power source (such as a battery 131) can be disposed on a side of the camera 11. The power source is configured to provide power to the camera 11 and the communication circuit, and the eyeball images captured by the camera 11 can be transmitted to the image processing circuit 12 through the communication circuit.

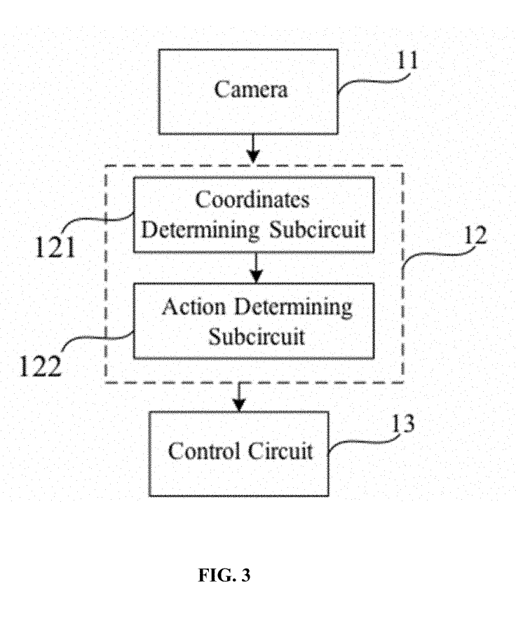

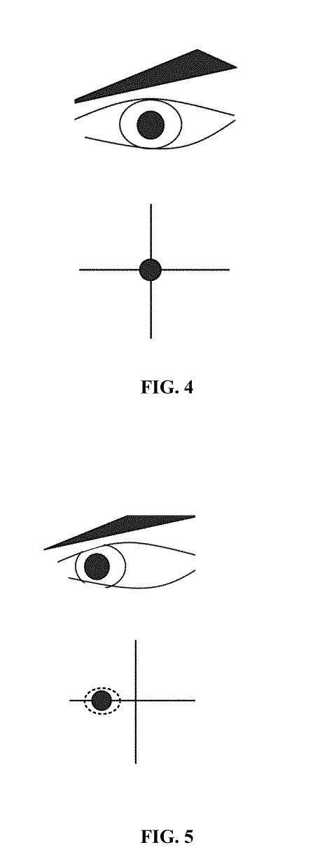

FIG. 3 shows a travel tool control device according to some embodiments of the present disclosure. As shown in FIG. 3, the image processing circuit 12 can include a coordinates determining subcircuit 121 and an action determining subcircuit 122.

The coordinates determining subcircuit 121 is configured, based on the differences in gray values among the whites, the iris, and the pupil of the eyeballs, to determine coordinates of the pupil of the user from the eyeball image of the user captured by the camera 11.

The action determining subcircuit 122 is configured to compare the coordinates of the pupil of the user in a current eyeball image (i.e. the eyeball image of the user captured by the camera 11) with the coordinates of the pupil in a plurality of pre-stored eyeball images for determining whether a difference between the coordinates of the pupil of the user in the current eyeball image and the coordinates of the pupil of any one pre-stored eyeball image is within a preset range, and if so, to determine that the user performs an eyeball action corresponding to the one pre-stored eyeball image. Herein the plurality of pre-stored eyeball images are eyeball images of the user that have been captured in advance.

The process by which coordinates of a pupil of the user are determined from the eyeball image of the user is a conventional method. As such, the process can include:

First, the coordinates of the pupil of the user can be determined based on the differences in gray values among the whites, the iris, and the pupil of the eyeballs of the user in the eyeball image of the user captured by the camera 11;

The above step can be realized by the following sub-steps: in a first sub-step, the image is segmented using the Otsu method (maximization of interclass variance) for binarization to thereby determine an edge of the iris, then in a second step, the coordinates of the center of the iris are determined by the gray projection method, and finally in a third sub-step, the coordinates of the center of the pupil can be determined by the circle-based Hough transform and the least-squares method.

Second, the coordinates of the pupil of the user obtained in the first step are compared with the coordinates of the pupil in a plurality of pre-stored eyeball images one after another. Herein the plurality of pre-stored eyeball images can be images with eyeball actions of the user captured in advance, for example at a first use of the user in the commissioning stage.

For example, FIG. 4 illustrates a pre-captured eyeball image of a user when he/she is looking straight ahead, and the coordinates of the pupil are specified as an origin of coordinates. FIG. 5 illustrates a pre-captured eyeball image of a user when he/she is looking left.

When the eyeballs turn left, i.e. the user is looking left, the relative position of the pupil shifts leftward from the center (i.e. the origin). Similarly, when the eyeballs turn right, up, or down, the position of the pupil can shift correspondingly, based on the relatively darker color of the pupil.

The position (i.e. coordinates) of the pupil in the whole eyeball can be accurately determined by the image analysis approaches (i.e. image recognition) as shown above in the first step. Then in the above second step, the coordinates of the pupil obtained in the first step are compared with the coordinates of the pupil in a plurality of pre-stored eyeball images one after another.

When compared with the pre-captured eyeball image as shown in FIG. 5, because the coordinates of the pupil obtained in the first step are within a preset range (i.e. the area encircled by the dotted line), a difference between the coordinates of the pupil obtained in the first step and the coordinates of the pupil of the pre-captured eyeball image (as illustrated in FIG. 5) is regarded as within the preset range, and finally the eyeball action of the user is determined as “LOOK LEFT”.

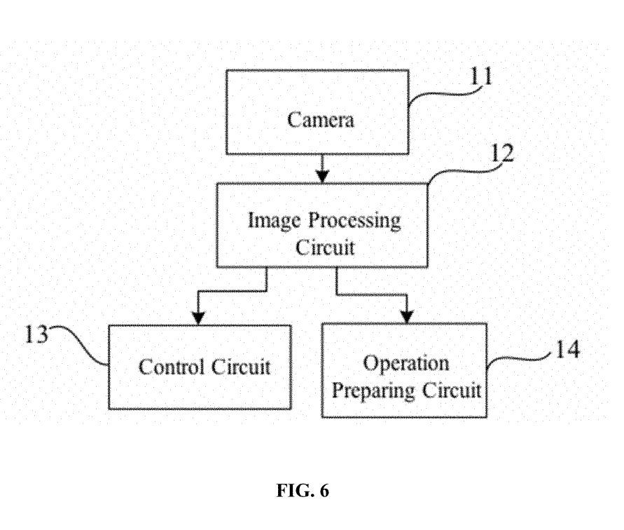

FIG. 6 is a schematic diagram of a travel tool control device according to some other embodiments of the disclosure. As shown in FIG. 6, the travel tool control device further comprises an operation preparing circuit 14, which is coupled with the image processing circuit 12 and is configured to determine whether the travel tool is at a preset operation ready state after the image processing circuit 12 recognizes the eyeball action of the user and receives a starting-eyeball-control instruction input by the user, and to generate a preparing-for-operation instruction if no, wherein the preparing-for-operation instruction is configured to instruct the travel tool to switch from a current state to the operation ready state. When the travel tool is at the operation ready state, the travel tool can be appropriate to perform an operation in accordance to a travel tool operation instruction that corresponds to an eyeball action of the user.

Before the travel tool performs an operation corresponding to an eyeball action of the user, it needs to determine the current state of the travel tool and determine whether it is appropriate to perform an operation. If no, the travel tool needs to adjust its state to switch to the operation ready state, which allows the travel tool to safely perform the above operation and thus can prevent accidents from happening. The operation ready state can be preset, and can vary depending on the operation to be performed.

Taken a wheelchair as an example, if the wheelchair is currently on a state of moving forward at a high speed. When the user instructs the wheelchair to turn left by means of eyeball action, it prompts the user “whether to start eyeball control?”. The user can send a starting-eyeball-control instruction through an eyeball action (e.g. “BLINK ONCE”), then after image capturing by the camera 11 and image processing by the image processing circuit 12, the operation preparing circuit 14 can, upon receiving a starting-eyeball-control instruction input by the user, determine that the current state is not appropriate to perform the “TURN LEFT” operation (i.e. determine that the wheelchair is not at the operation ready state), and can then generate a preparing-for-operation instruction, which in turn instructs the wheelchair to slow down or stop, so as to prepare the wheelchair for performing the “TURN LEFT” operation corresponding to the eyeball action to thereby avoid the accident from happening during left turn of the wheelchair.

The travel tool can be configured to feedback or record a result of a previous operation to thereby obtain the current state. If the operation preparing circuit 14 determines that the current state of the travel tool is appropriate for performing an operation corresponding to an eyeball action, a preparing-for-operation instruction is not generated and the wheelchair can directly perform the operation.

The current state of the travel tool can include, but is not limited to, the moving speed, moving direction, and a respective angle for each wheel of the travel tool.

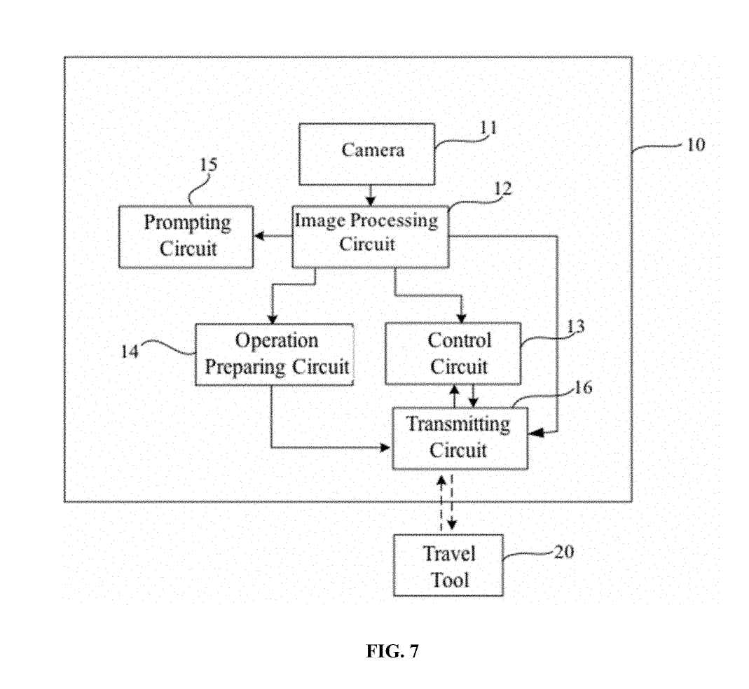

FIG. 7 is a schematic diagram of a travel tool control device according to some other embodiments of the disclosure. As shown in FIG. 7, the travel tool control device is on the basis of the travel tool control device as shown in FIG. 6 and described above, and further comprises a prompting circuit 15 and a transmitting circuit 16.

The prompting circuit 15 is configured, after the image processing circuit 12 recognizes the eyeball action of the user, to prompt the user whether to perform an operation corresponding to the eyeball action. The transmitting circuit 16 is configured, upon receiving a confirming instruction from the user, to transmit the travel tool operation instruction to a motor driver of the travel tool.

Herein the prompting circuit 15 can prompt the user through audios, images, or other prompting manners. The transmitting circuit 16 can send travel tool operation instructions after receiving the confirming instruction from the user, and thus the travel tool operation instructions can be withdrawn before transmission, so as to avoid false operations and to improve safety.

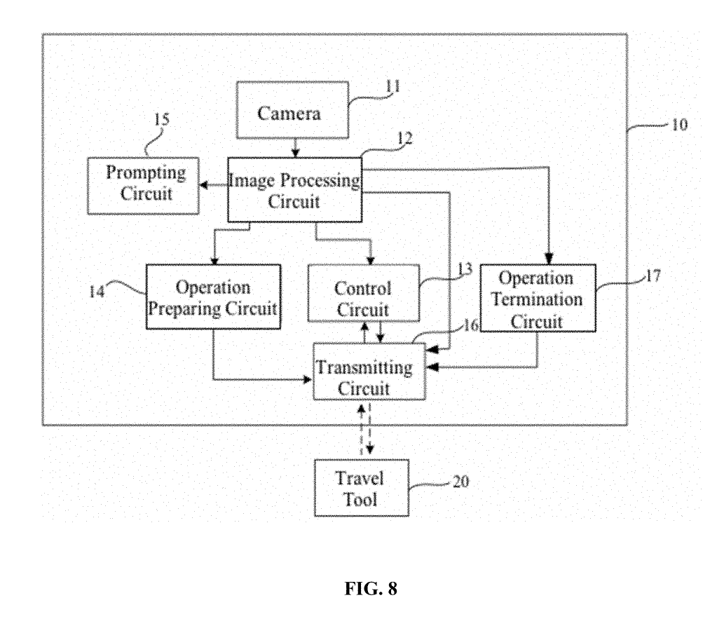

FIG. 8 is a schematic diagram of a travel tool control device according to some other embodiments of the disclosure. As shown in FIG. 8, the travel tool control device is on the basis of the travel tool control device as shown in FIG. 7 and described above, and further comprises an operation termination circuit 17, which is configured to receive a terminating-eyeball-control instruction input by the user and to generate a terminating-operation instruction based on the terminating-eyeball-control instruction so as to stop the travel tool and to shut down the transmitting circuit 16. As such, after the user inputs the terminating-eyeball-control instruction, the operation termination circuit 17 instructs the travel tool to stop and shuts down the transmitting circuit 16, thereby capable of avoiding false operations.

The above mentioned starting-eyeball-control instruction, the confirming instruction, and the terminating-eyeball-control instruction can all be obtained through recognition of the camera-captured eyeball images of the user by the image processing circuit.

By means of the travel tool control device as described above, an eyeball control can be realized to operate the travel tool, without the need to move legs, arms, hands, or other parts of the body. As such, the problem that conventional travel tools, such as wheelchairs, are difficult to operate for those with disabilities or handicaps, can be effectively solved, and at the same time, the safety can be guaranteed, and the false operations can be avoided.

In another aspect, the present disclosure provides a travel tool system. The travel tool system comprises a travel tool and a travel tool control device according to any of the embodiments as described above.

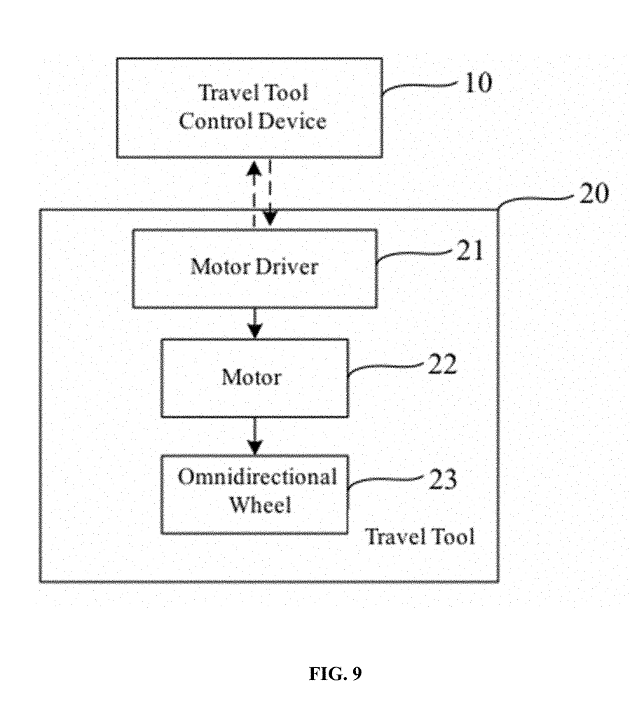

The travel tool can be a wheelchair, and as shown in FIG. 9, in a travel tool system according to some embodiments of the present disclosure, the wheelchair 20 can include an omnidirectional wheel 23, a motor 22 for driving the omnidirectional wheel 23, and a motor driver 21 for controlling the motor 22.

An instruction outputting end of a travel tool control device 10 can be coupled with the motor driver 21. Herein coupling between the control device 10 and the motor driver 21 can include communication, which can be a wired communication or a wireless communication. The wireless communication can be realized by a wireless adapter.

In the travel tool system (e.g. wheelchair) as described above, an eyeball control can be realized to operate the travel tool, without the need to move legs, arms, hands, or other parts of the body. As such, the problem that conventional travel tools, such as wheelchairs, are difficult to operate for those with disabilities or handicaps, can be effectively solved.

According to some embodiments, a travel tool in the travel tool system as described above can further include a stop button and a safety control panel, as illustrated in FIG. 11. The stop button 171 is configured to receive, and to send to the safety control panel 161, a forced stop instruction. The safety control panel 161 is coupled respectively to the stop button 171 and the motor driver 21, and is configured to send a stopping-motor instruction to the motor driver 21 upon receiving the forced stop instruction from the stop button 171. In some embodiments, the safety control panel 161 can be further coupled to an alarm indicator 181, and is configured to control the alarm indicator 181 to alarm to the surrounding environment upon receiving the forced stop instruction from the stop button 171.

The above configuration serves the following purpose. A user of the travel tool system is typically someone with disabilities or handicaps, and thus if some situation (e.g. an accident) requires that the travel tool is stopped, the eyeball controlled operation is typically slow and thus it will be more convenient and fast by having an assistant or a caregiver to press the stop button to thereby realize an emergency braking of the travel tool.

In yet another aspect, the present disclosure provides a method for controlling a travel tool. The method comprises the following steps:

Step 1: capturing an eyeball image of a user;

Step 2: recognizing an eyeball action of the user based on the eyeball image of the user via image processing and recognition;

Step 3: generating a travel tool operation instruction based on the eyeball action of the user.

In the method for controlling a travel tool as described above, an eyeball image of a user is first captured, then by image processing and recognition, the eyeball action of the user can be recognized based on the eyeball image of the user, and finally the eyeball action of the user can be translated into a travel tool operation instruction. As such an eyeball control can be realized to operate the travel tool, without the need to move legs, arms, hands, or other parts of the body. Consequently, the problem that conventional travel tools, such as wheelchairs, are difficult to operate for those with disabilities or handicaps, can be effectively solved.

Prior to Step 3, the method can further comprise: receiving a starting-eyeball-control instruction from the user, determining whether a current state of the travel tool is a preset operation ready state, and if no, generating a preparing-for-operation instruction, wherein the preparing-for-operation instruction is configured to instruct the travel tool to switch from a current state to the operation ready state. When the travel tool is at the operation ready state, the travel tool can perform an operation based on the travel tool operation instruction corresponding to the eyeball action of the user.

After Step 3, the method can further comprise:

Step 4: prompting the user whether to perform an operation corresponding to the eyeball action, and transmitting the travel tool operation instruction to a motor driver of the travel tool upon receiving a confirming instruction from the user.

Herein the travel tool operation instruction is sent after receiving a confirming instruction from the user, and by such a configuration, the travel tool operation instruction can be withdrawn before sending, thereby capable of avoiding false operations and improving safety.

According to some embodiments of the present disclosure, the method for controlling a travel tool can further comprise:

Step 5: receiving a terminating-eyeball-control instruction from the user and generating a terminating-operation instruction based on the terminating-eyeball-control instruction so as to stop the travel tool and to terminate sending travel tool operation instructions to the travel tool.

The following is a detailed description of specific embodiments of a travel tool and the method for controlling the same.

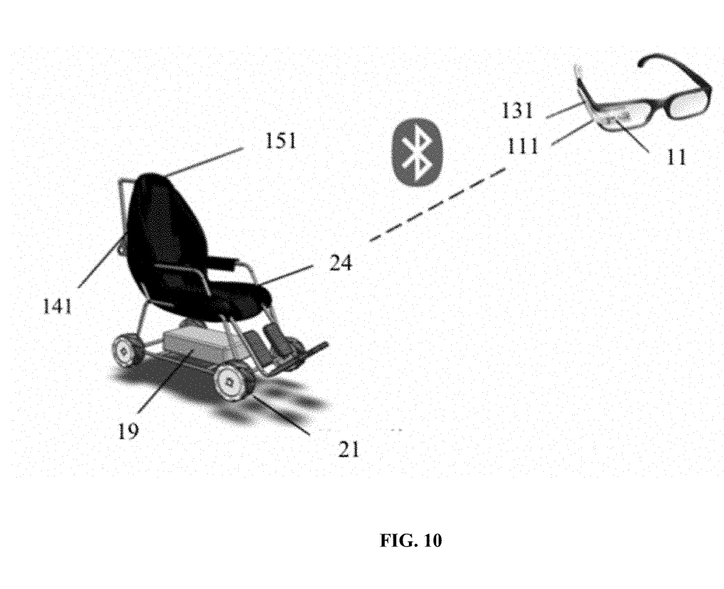

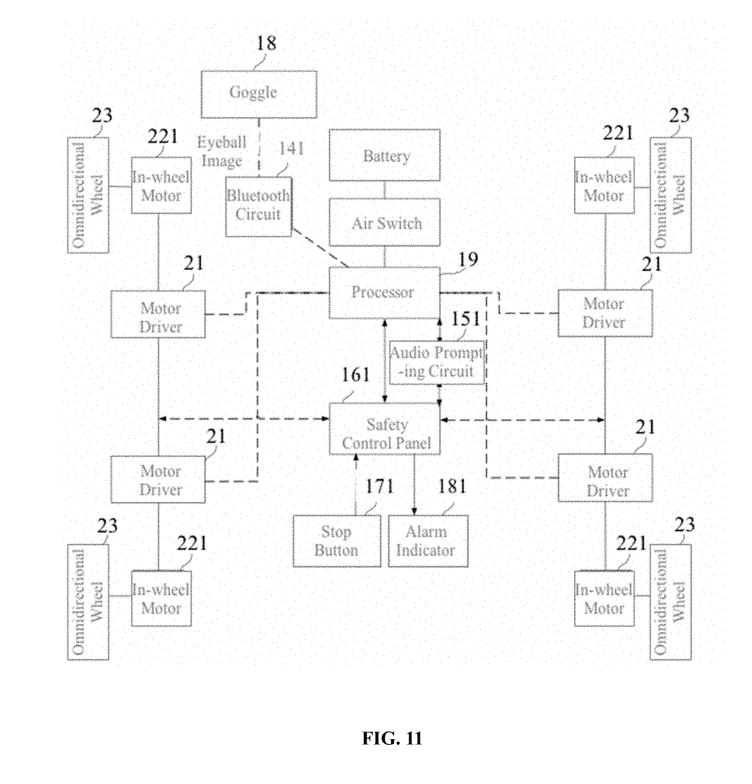

FIG. 10 and FIG. 11 illustrates a wheelchair system according to some embodiments of the present disclosure.

As shown in FIG. 10 and FIG. 11, the wheel chair system comprises a goggle 18 and a wheelchair. The goggle 18 comprises a camera 11, a Bluetooth wireless communication circuit 111, and a battery 131, and is configured to capture and send eyeball images of a user in a real-time mode.

The wheelchair comprises a chair 24, a set of four omnidirectional wheels 23 mounted on a bottom of the chair 24, a set of in-wheel motors 221, and a set of motor drivers 21, wherein each in-wheel motor 221 is coupled with an omnidirectional wheel 23 and with a motor driver 21. The wheelchair also comprises other parts, including a processor 19, a storage circuit (not shown in the figures), a Bluetooth circuit 141, an audio prompting circuit 151, a power source (e.g., a battery) and an air switch, etc.

The wheelchair is configured to receive an eyeball image of the user and recognize an eyeball action of the user through an image analysis algorithm, and the processor 19 can send a wheelchair operation instruction corresponding to the eyeball action of the user such that the omnidirectional wheel 23 can adjust a moving direction, move forward, move backward, or make turns, and so on.

It should be noted that by executing a preset software program, the processor 19 can realize the functions of the various circuits as mentioned above in some embodiments of the present disclosure. For example, the processor 19 can realize the functions of the image processing circuit 12, the control circuit 13, the operation preparing circuit 14, and the operation termination circuit 17, and can partially realize the function of the transmitting circuit 16.

The correspondence relationship between eyeball actions and respective wheelchair operation instructions is exemplified in TABLE 1. As shown in the table, the eyeball actions “LOOK LEFT”, “LOOK RIGHT”, “LOOK UP” and “LOOK DOWN” correspond respectively to the wheelchair moving left, right, forward, and backward. The eyeball actions “BLINK ONCE”, “BLINK TWICE”, “BLINK THREE TIMES” correspond respectively to confirmation, stopping, and starting. It should be mentioned that the above correspondence relationship can be customized.

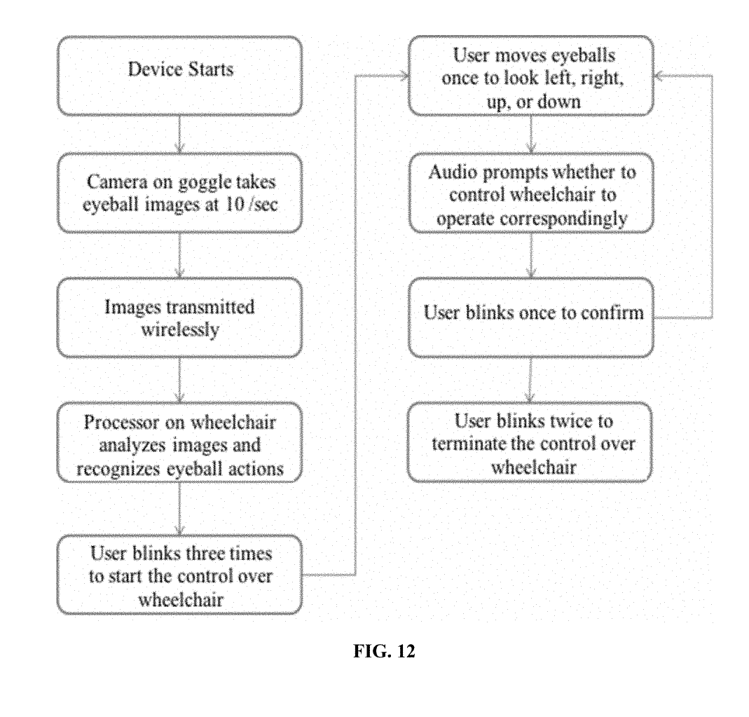

FIG. 12 illustrates a working flowchart of a wheelchair system according to some embodiments of the present disclosure. In the wheelchair system, a goggle integrated with a camera 1 is worn by a user; and if started, the camera 11 can take real-time eyeball images of the user at a speed of 10/sec (the speed can be customized); then the eyeball images of the user can be transmitted to a processor 19 via a Bluetooth wireless communication; the processor 19 can process the eyeball images of the user in real-time manner to thereby recognize the eyeball actions of the user.

Before the user starts to control the wheelchair, the user needs to blink three times to obtain the access control. When the user turn his/her eyeballs left, right, up, or down once, the system can provide a prompt by audio as to whether to move left, right, forward, or backward, based on the eyeball image recognition result and the correspondence table between the eyeball actions and the wheelchair operation instructions. After the user blinks once for confirmation, the wheelchair can perform operations corresponding to the eyeball actions, until the user wants to stop, when the user can blink twice to terminate the control over the wheelchair.

It should be noted that for a same wheelchair operation instruction, each omnidirectional wheel may have different nominal operation.

The omnidirectional wheels in the embodiments as described above can preferably be Mecanum wheels. A Mecanum wheel is based on a traditional wheel and comprises a plurality of freely rotatable small rollers, disposed on the rim of the wheel and having an angle of alpha (usually 45 degrees).

As such when the wheel (i.e. center wheel) is rolling, the small rollers can have a lateral movement. The coordination of four Mecanum wheels of the wheelchair allows the wheelchair system to achieve an all-directional movement. In addition, the wheelchair system having the Mecanum wheels as described above has advantages such as a strong bearing capacity, a simple structure, and flexible motion control, and is thus suitable for a wheelchair.

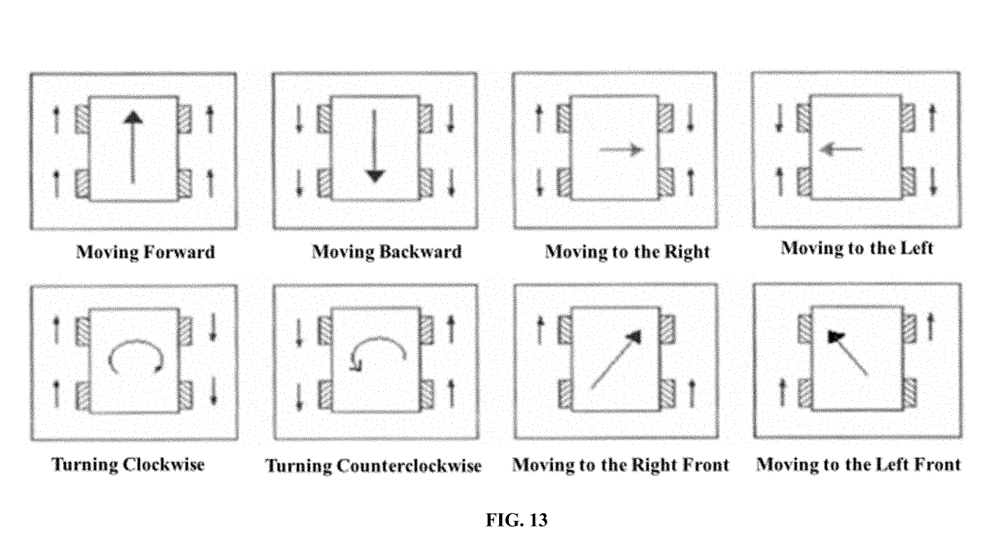

FIG. 13 illustrates the coordination of all four wheels (i.e. Mecanum wheels) in a wheelchair realizing various major movements of the wheelchair.

When the wheelchair is moving forward, all four wheels (i.e. Mecanum wheels) are rotating forward;

When the wheelchair is moving backward, all four wheels are rotating backward;

When the wheelchair is moving to the right, the front left wheel and the rear right wheel are rotating forward, whereas the front right wheel and the rear left wheel are rotating backward;

When the wheelchair is moving to the left, the front left wheel and the rear right wheel are rotating backward, whereas the front right wheel and the rear left wheel are rotating forward;

When the wheelchair is turning clockwise, the front left wheel and the rear left wheel are rotating forward, whereas the front right wheel and the rear right wheel are rotating backward;

When the wheelchair is turning counter-clockwise, the front left wheel and the rear left wheel are rotating backward, whereas the front right wheel and the rear right wheel are rotating forward;

When the wheelchair is moving to the right front, the front left wheel and the rear right wheel are rotating forward, and the front right wheel and the rear left wheel are not rotating;

When the wheelchair is moving to the left front, the front right wheel and the rear left wheel are rotating forward, and the front left wheel and the rear right wheel are not rotating.

In the above, rotating forward or backward of each Mecanum wheel is the rotational direction of the center wheel in the each Mecanum wheel.

In a Mecanum wheel, each roller can rotate independently, and when the Mecanum wheel is rotating, the combined velocity of the Mecanum wheel is perpendicular to the rollers and can be divided into a longitudinal direction and a transverse direction.

Provided herein is an example with a wheelchair moving to the right. As shown in the diagram of “Moving to the RIGHT” in FIG. 13, the direction of each arrowhead besides each Mecanum wheel illustrates the rotational direction of the corresponding Mecanum wheel (i.e. the rotational direction of the center wheel of the Mecanum wheel). If the velocity of each Mecanum wheel is divided into a longitudinal direction and a transverse direction, it can be found that the velocity in the longitudinal direction is cancelled and that only the velocity in the transverse direction (to the right direction) is left. As such, the wheelchair can realize a movement to the right.

The above is common knowledge in the field and its description is skipped herein for simplicity.

In the wheelchair system as described above, control over the wheelchair can be realized by monitoring and recognizing eyeball actions of a user, which include blinking and moving of the eyeballs. Specifically, because omnidirectional wheels are employed in the wheelchair system, by a specific eyeball action and a corresponding coordinated rotation of each individual wheel, the control over the moving of the wheelchair can be realized even at a turning radius of zero.

One control mechanism according to some embodiments of the present disclosure can be as follows.

A real-time eyeball image of a user is compared with pre-set image samples that have been pre-determined by a camera, and a change of the coordinates of the center of the pupils is determined. Then an audio is provided to prompt the user whether or not to take a certain action. After confirmation from the user, a processor sends out an instruction, which, by means of a motor driver, can respectively control each motor to thereby coordinately control each of the omnidirectional wheel so as to realize an operation of the wheelchair that corresponds to the eyeball action of the user.

Herein the eyeball actions “LOOK LEFT”, “LOOK RIGHT”, “LOOK UP” and “LOOK DOWN” correspond respectively to the wheelchair moving left, right, forward, and backward. In order to avoid the interference of unconscious moving of the eyeballs, the validity of an action can be confirmed by blinking.

In any of the embodiments of the present disclosure as described above, the numbers of steps do not impose limitations for defining the sequence of the steps, and any change made by an ordinary person in the field with regard to the sequence of the steps shall be considered within the scope of the present disclosure.

The various embodiments of the present disclosure are described in a progressive manner, and description of a same or similar part among different embodiments can be referenced to one another.

It should be noted that all or some steps of the method as described above can be realized by means of a computer program instructing various corresponding hardwares. Herein the computer program can be stored in a computer readable storage medium, and when executing, the computer program can comprise the steps of the method as described in any of the above embodiments. The storage medium can be a disc, a CD, a read-only memory (ROM), a random access memory (RAM), etc. There are no limitations herein.

All references cited in the present disclosure are incorporated by reference in their entirety. Although specific embodiments have been described above in detail, the description is merely for purposes of illustration. It should be appreciated, therefore, that many aspects described above are not intended as required or essential elements unless explicitly stated otherwise.

Various modifications of, and equivalent acts corresponding to, the disclosed aspects of the exemplary embodiments, in addition to those described above, can be made by a person of ordinary skill in the art, having the benefit of the present disclosure, without departing from the spirit and scope of the disclosure defined in the following claims, the scope of which is to be accorded the broadest interpretation so as to encompass such modifications and equivalent structures.

1. A method for controlling a travel tool by a user, comprising:
capturing an eyeball image of the user;
recognizing an eyeball action of the user based on the eyeball image of the user; and
generating a travel tool operation instruction to instruct the travel tool to perform an operation corresponding to the eyeball action of the user.

2. The method of claim 1, wherein the recognizing an eyeball action of the user based on the eyeball image of the user comprises:
determining coordinates of at least one pupil from the eyeball image of the user; and
determining an eyeball action of the user by comparing the coordinates of the at least one pupil with coordinates of the at least one pupil in at least one pre-stored eyeball images of the user, wherein each pre-stored eyeball image of the user corresponds to one eyeball action of the user.

3. The method of claim 2, wherein the determining coordinates of at least one pupil from the eyeball image of the user is based on differences in gray values among whites, iris, and pupil in the eyeball image of the user.

4. The method of claim 2, wherein the determining an eyeball action of the user by comparing the coordinates of the at least one pupil with coordinates of the at least one pupil in at least one pre-stored eyeball images comprises:
determining whether a difference between the coordinates of the at least one pupil and the coordinates of the at least one pupil of any pre-stored eyeball image is within a preset range; and
if so, determining that the eyeball action of the user is an eyeball action corresponding to the any pre-stored eyeball image.

5. The method of claim 1, further comprising, between the recognizing an eyeball action of the user based on the eyeball image of the user and the generating a travel tool operation instruction to instruct the travel tool to perform an operation corresponding to the eyeball action of the user:
starting an eyeball control upon receiving a starting-eyeball-control instruction from the user; and
determining whether the travel tool is in an operation ready state, and if no, generating a preparing-for-operation instruction to instruct the travel tool to adjust to the operation ready state to thereby allow the travel tool to perform an operation corresponding to the eyeball action of the user.

6. The method of claim 5, further comprising, after the generating a travel tool operation instruction to instruct the travel tool to perform an operation corresponding to the eyeball action of the user:
prompting the user whether to perform the operation corresponding to the eyeball action of the user; and
transmitting the travel tool operation instruction to the travel tool upon receiving a confirming instruction from the user.

7. The method of claim 6, further comprising, after the transmitting the travel tool operation instruction to the travel tool upon receiving a confirming instruction from the user:
terminating the eyeball control upon receiving a terminating-eyeball-control instruction from the user.

8. The method of claim 1, wherein the eyeball action comprises LOOK LEFT, LOOK RIGHT, LOOK UP, and LOOK DOWN, corresponding to the travel tool moving left, right, forward, and backward, respectively.

9. A travel tool control device, comprising:
a camera, configured to capture an eyeball image of a user;
an image processing circuit, coupled with the camera and configured to recognize an eyeball action of the user based on the eyeball image of the user; and
a control circuit, coupled with the image processing circuit and configured to generate a travel tool operation instruction to instruct the travel tool to perform an operation corresponding to the eyeball action of the user.

10. The travel tool control device of claim 9, wherein the image processing circuit comprises:
a coordinates determining subcircuit, configured to determine coordinates of at least one pupil from the eyeball image of the user; and
an action determining subcircuit, configured to determine the eyeball action of the user by comparing the coordinates of the at least one pupil with coordinates of the at least one pupil in at least one pre-stored eyeball images of the user, wherein each pre-stored eyeball image of the user corresponds to one eyeball action of the user.

11. The travel tool control device of claim 9, further comprising an operation preparing circuit, coupled with the image processing circuit and configured:
to determine whether the travel tool is in an operation ready state after the image processing circuit recognizes the eyeball action of the user and receives a starting-eyeball-control instruction from the user; and
if no, to generate a preparing-for-operation instruction to instruct the travel tool to adjust to the operation ready state to thereby allow the travel tool to perform an operation corresponding to the eyeball action of the user.

12. The travel tool control device of claim 9, further comprising:
a prompting circuit, configured, after the image processing circuit recognizes the eyeball action of the user, to prompt the user whether to perform the operation corresponding to the eyeball action of the user; and
a transmitting circuit, configured, upon receiving a confirming instruction from the user, to transmit the travel tool operation instruction to the travel tool.

13. The travel tool control device of claim 12, further comprising an operation termination circuit, configured:
to receive a terminating-eyeball-control instruction from the user; and
to generate a terminating-operation instruction based on the terminating-eyeball-control instruction from the user so as to stop the travel tool and to shut down the transmitting circuit.

14. The travel tool control device of claim 9, further comprising a communication circuit, coupled with the camera and the image processing circuit, and configured to transmit the eyeball image of the user to the image processing circuit.

15. The travel tool control device of claim 9, wherein the camera is on a goggle worn by the user.

16. A travel tool system, comprising a travel tool and a travel tool control device according to claim 9.

17. The travel tool system according to claim 16, wherein the travel tool comprises:
at least one wheel, configured to provide a moving means for the travel tool;
a motor, configured to drive the at least one wheel; and
a motor driver, coupled with an instruction outputting end of the travel tool control device and configured to control the motor.

18. The travel tool system according to claim 17, wherein the at least one wheel comprises at least one omnidirectional wheel.

19. The travel tool system according to claim 18, wherein the at least one omnidirectional wheel comprises at least one Mecanum wheel.

20. The travel tool system according to claim 16, further comprising:
a stop button, configured to receive a forced stop instruction; and
a safety control panel, coupled respectively to the stop button and the motor driver, and is configured to send a stopping-motor instruction to the motor driver upon receiving the forced stop instruction from the stop button.
